(19) United States
(12) Patent Application Publication
(10) Pub. No.: US 2007/0183637 A1
(43) Pub. Date: Aug. 9, 2007

(54) METHOD FOR GENERATION OF AN X-RAY IMAGE

(76) Inventors: Klaus-Peter Kreuzer, Furth (DE); Michael Leigart, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/616,367

(22) Filed: Dec. 27, 2006

(30) Foreign Application Priority Data
Dec. 27, 2005 (DE) 10 2005 062 445.6

(51) Int. Cl. G06K 9/00

(52) U.S. Cl. 382/128

(57) ABSTRACT

In a method for generation of an x-ray image of a subject in a patient, a first x-ray image showing the subject in the patient is acquired. A subject image containing only image information in the imaging region of the subject is created from the first x-ray image by image regions of the first x-ray image that do not belong to the imaging region of the subject being removed. A second x-ray image of the patient is acquired in the region of the subject. The subject image is associated with the second x-ray image with positional accuracy and both are merged into a sum image.

### BACKGROUND OF THE INVENTION

1. Field of the Invention

The invention concerns a method for generation of an x-ray image.

2. Description of the Prior Art

Modern medical technology cannot be imagined without the generation of x-ray images. X-ray images, normally of living people or animals as patients, are generated by a physician or the like in the framework of a diagnosis or treatment. The goal is normally the visual representation of a subject of interest inside the patient, for example of a bone, organ, tissue structure or vessel structure.

In modern surgery x-ray images are used not only for diagnostic purposes but also during a treatment, primarily in the case of non-invasive or minimally-invasive procedures in the body of the patient. Such x-ray images, what are known as live x-ray images, serve, for example, to display to the physician the current position of an instrument inserted into the patient body.

A procedure in vascular surgery, known as the subtraction method, is explained here as an example. A native mask image (thus an x-ray exposure that depicts the anatomy of the head, for example bones and tissue) of the patient is initially generated.

An x-ray image of the vessel tree in the head of the patient is subsequently generated. For this contrast agent is administered to the patient and a series of x-ray images of the head are generated. An accumulated mask image (Max OP image) of the contrast agent bolus flowing through the head is generated, in which accumulated mask image both the contrasted blood vessels and again the remaining anatomy of the head of the patient are shown. The image is subsequently subtracted from the other. The remaining anatomy of the head just mentioned, with the exception of the vessel tree, can thus ideally be made to disappear so that only the vessel tree remains as a result. This then appears isolated or, respectively, alone in the result image.

Such a generated x-ray image as a result image in which the desired body structure of the patient (in the example the vessel tree) is well recognizable is widely used today in medicine as what is known as a medical map or roadmap, which the physician uses to orient himself or herself in a subsequent procedure.

Additionally, further live x-ray images of the patient on which, for example, the instrument (for instance a catheter inserted into the blood vessel) used in the vascular surgery is visible are generated at this later point in time, namely during the procedure. Since the patient is not furthermore acted upon by contrast agent, however, the vessel tree is no longer visible in the live image. For example, the physician recognizes the utilized instrument on the live image but not the subject structure (thus the vessel tree) itself. The physician thus does not know precisely where the instrument is located relative to the vessel tree.

As mentioned, the physician then uses the roadmap x-ray image together with the live image. Both x-ray images are, for example, simultaneously shown on a single screen, i.e. blended into one another. Problems hereby arise, however, in the dynamic range of the representation or in the contrast scope of the representation. For example, the live image may be covered over by particularly high-contrast structures in the roadmap image, such that the physician can no longer satisfactorily detect the instrument, or parts of the roadmap image may be too low-contrast, such that it is overlapped by structures in the live image and therefore no longer offers the physician help for orientation in the live image. The representation of small, low-contrast subjects (such as, for example, a catheter) also prevents or worsens over-modulation effects.

The joint representation or mixing of the live image and the medical map is therefore in need of improvement.

It is known to increase the signal-noise ratio an x-ray image by increasing the dose of the x-ray radiation during the acquisition of the various x-ray images. A better representation is in fact achieved, but this procedure is disadvantageous with regard to the dose exposure of the patient.

For orientation of the physician, it is known to place on the patient metallic (and thus radiologically high-contrast) marking needles that are more clearly visible on the x-ray image than the subject or instrument.

It is also known to display the roadmap image and the live image in temporal alternation, thus successively on the same screen or simultaneously on various screens that are, for example, arranged next to one another. With the alternating representation, the physician then marks locations in the roadmap that are important to him, for example with a felt-tip pen on the screen. The live image is subsequently faded into the same screen and the physician orients himself or herself on the handwritten markings. With the representation on two screens the physician uses visual judgment in order to simultaneously use both pieces of image information.

### SUMMARY OF THE INVENTION

An object of the present invention is to provide an improved method for generation of an x-ray image of a subject in a patient.

The object is achieved in accordance with the invention by a method that proceeds as follows. A first x-ray image is initially acquired that shows a subject of interest in the patient. The subject is thus sufficiently clearly recognizable for the intended purpose. For example, given the acquisition of a vessel tree the smallest vessels should be able to be recognized with sufficient clarity.

From the first x-ray image a subject image is created that contains image information only in the image region encompassing the subject of interest. The subject image is created such that image regions of the first x-ray image that do not belong to the imaging region of the subject are removed.

Furthermore, a second x-ray image of the patient is acquired in the region of the subject. As already mentioned, the subject may no longer be clearly recognizable in such an image but; its immediate surroundings are. For example, since the treating physician is furthermore interested in the region of the subject (for example as a target region of the treatment), the second x-ray image provides current image information of the region of the subject (possibly also of the subject itself) but at a quality that is insufficient for the physician. For example, the instrument utilized by the physician can be seen in the second x-ray image.

The subject image is subsequently associated with positional accuracy with the second x-ray image, such that the image information in the imaging region of the subject from the first x-ray image is also blended in at the location of the subject in the second x-ray image. The subject image and the second x-ray image are then combined into a sum image or, in other words, are faded (blended) into one another. It is insignificant which image is faded into the other; what is important is the joint representation in a resulting sum image as an x-ray image.

Since the subject image contains image information only in the imaging region of the subject, the image information surrounding the subject in the second x-ray image and thus in the sum image is neither disrupted nor adulterated by the superimposed subject image. For example, the dynamic range of the second x-ray image remains wholly retained these and does not have to be adapted to the subject image. Nevertheless, image information is clearly shown in the region of the subject (thus in the region of interest) in the sum image such that, for example, the treating physician can clearly see the subject or the placement of the medical instrument relative thereto.

For generation of the subject image the first x-ray image is processed with known image processing method; For example, the subject or its outline (contour) can be identified or (in medical terminology) segmented in the first x-ray image. The subject region thus can be delimited from the remaining image region. The subject (i.e. its image) is thus clearly identified.

The subject itself is thereby initially retained in a lifelike image corresponding to the first x-ray image, but, the surrounding image information that does not belong to the subject is deleted from the subject image. In other words, a subject image is created in which the subject in an initially lifelike representation appears, so to speak, to be standing in empty space.

In the known subtraction method it is also sought to delete image information outside of the subject, but, in contrast to the inventive method no detection of the subject hereby ensues. Differences outside' of the subject in the images to be subtracted that could lead to artifacts or to image contents are not present. No artifacts can arise in the inventive procedure since the image content outside of the identified subject is, completely removed.

The image information designated as corresponding to the subject in the subject image is arbitrary. Many possibilities exist for making this designation. makes its easier for the observer to differentiate image information from the subject image and second x-ray image in the sum image. The observer can thus, for example, immediately note variations in the second x-ray image that are important for the treatment, for example perceive them in real time and react to them.

The image contrast and/or the brightness of the subject image and/or of the first x-ray image can be prepared in a non-linear manner. This leads to an emphasis of regions of particular interest in the subject image and therewith in the sum image.

The subject image and/or the second x-ray image can be weighted when producing the combination or fusing into the sum image. For example, a representation adapted to the personal preferences of the observer is possible. For example, if the primary emphasis lies on the observation of the second x-ray image, this can be more strongly weighted relative to the subject image and thereby subjectively appear in the foreground of the observation.

Many possibilities for image processing also exist for the mixing of the subject image and of the second x-ray image into one another to form the sum image. The subject image can be mixed into the second x-ray image by, for example, image overlay. In particular no image processing whatsoever need occur in the second x-ray image; in other words, the subject image is placed over the second x-ray image in the form of or comparable to a printed transparency film. Brightness, contrast and other image parameters of both subject image and second x-ray image thus can be separated from one another and be regulated independently of one another in order to find an image setting adapted to the observer, for example with regard to brightness or contrast.

The subject image and the second x-ray image can naturally also be mixed with one another in a known manner. Well-known image mixers exist for this.

If the subject x-ray image is acquired with contrast agent, the subject can be graphically emphasized. A particularly clear representation of the subject is thus available in the first x-ray image, which is why the imaging region of the subject can also be particularly easily or clearly recognized and delimited. For example, the image information in the region that does not belong to the imaging region of the subject can thus be easily detected and thus deleted or removed.

The first x-ray image and/or the second x-ray image can be acquired as a native image or subtraction image of the patient. Various preferences of, for example, the physicians considering the x-ray images can be taken into account here. For example, in addition to the subject, other body structures of the patient can also be recognized in a native image. In a subtraction image it is sought to optimally show only the subject of interest and just delete or to remove all other image information.

The sum image of a vessel structure of the patient can be generated as a subject. The sum image as a mixture of the subject image and second x-ray image is particularly useful in the case of a vessel structure of the patient as a subject. Vessel structures in live x-ray images as second x-ray images are often not recognizable or are only insufficiently recognizable. The inventive method is directly, particularly suitable for this in order to supply to the operating physician image information of the vessel structure in connection with a live or real-time x-ray image by the graphical emphasis of the subject in the subject image.

The inventive method is therefore particularly suitable when the sum image is generated in the framework of a vascular surgery procedure.

It is particularly advantageous to generate the -sum image as a roadmap method for orientation on the subject. The image information of the graphically

The subject image can be created by edge extraction of the first x-ray image. For example, both the edges and the lumen of the subject can be differentiated and thus be particularly clearly emphasized in the subject image. If only the edges of the subject are shown, only the subject edge of the subject is thus visible in the sum image, so the image information of the subject is supplied from the second x-ray image such as, actively, for example “live” in real time. A real-time sum image of the subject in its real surroundings is thus available to the observer, so artificial limits (if used) of the subject image are visible for orientation.

The subject lumen delimited by the edges could also be shown, for example, in uniform, semi-transparent coloration and be superimposed on the x-ray image such that, for example, a live image of the subject is in turn available to the observer, but without artificial blending and possibly interfering subject edges. Only the subject is then marked, for example by the coloration.

The subject image can thus also be created by coloration of the first x-ray image and/or of the subject image itself. The coloration can range both in the black-and-white spectrum (thus corresponding in a lifelike manner to an x-ray image) or in color. By coloring of the subject image and/or of the second x-ray image it is particularly clear in the result which image information (namely, for example, the black-and-white) is to be associated with the second x-ray image and which image information (for example colored) is to be associated with the subject image. The observer thus obtains particularly good support in differentiating the portions of the live image from those of the road map image in the form of the subject image in the sum image.

The subject image can be created by normalization of the brightness of the second x-ray image and/or of the subject image. Such normalized brightness also emphasized subject from the subject image, which image information “superimposed” on the second x-ray image as a roadmap, serves for optimal orientation on the subject for the treating doctor.

### DESCRIPTION OF THE DRAWINGS

FIG. 1 is a flowchart for generation of angiography x-ray exposures of a patient for preparation of a vascular surgery procedure.

FIG. 2 is a flowchart for the implementation of the vascular surgery procedure with further processing of the x-ray images from the angiography according to FIG. 1.

### DESCRIPTION OF THE PREFERRED EMBODIMENTS

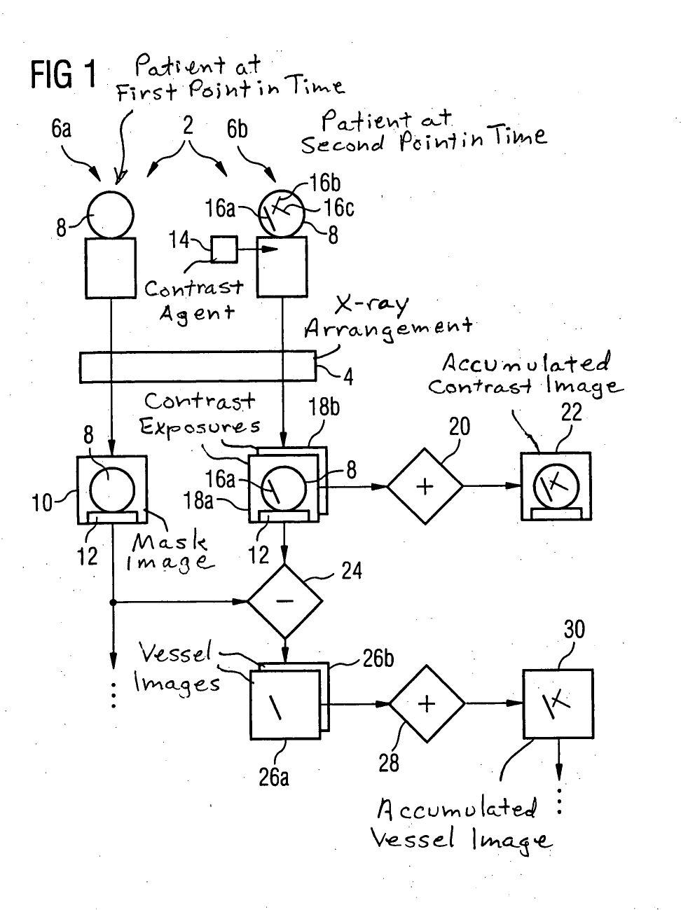

FIG. 1 shows a patient 2 and an x-ray arrangement 4. The patient is shown at two differing points in time 6a and 6b in connection with the x-ray arrangement 4. A vascular surgery procedure on the patient 2 is to be implemented at the head 8.

Using the x-ray arrangement 4 a native x-ray image (called a mask image 10) of the patient 2, in particular the head 8, is therefore produced at the first point in time 6a. The mask image 10 shows the head 8 of the patient as well as a portion of his further anatomy such as, for example, a portion of his shoulder region 12.

Contrast agent 14 is administered to the patient at a later point in time 6b, for example a few seconds after the point in time 6a. The contrast agent 14 flows through blood vessels 16a-c in the patient 2, namely the head 8. Since the contrast agent 14 slowly spreads through the vessel tree of the patient from an injection point (not shown), a contrast agent bolus flows through the head 8 of the patient 2. A series of x-ray images is acquired with the aid of the x-ray arrangement 4 while the contrast agent 14 flows through the patient 2.

Two x-ray images that are representative of this in the form of contrast exposures 18a,b are shown in FIG. 1. Here as well these are again native x-ray images. The head 8 and the shoulder region 12 of the patient 2 are visible in the x-ray image 18a in addition to the blood vessel 16a in which the contrast agent bolus is located at acquisition time.

Given further flow of the contrast agent 14 in the head 8 of the patient, the contrast agent 14 disappears from the blood vessel 16a and furthermore flows through the smaller blood vessels 16b,c. The further contrast exposure 18b (only symbolically shown in FIG. 1) of this is produced in the further course. In this contrast exposure 18b the blood vessel 16a is not longer recognizable, however the blood vessels 16b, c are. Each of the contrast exposures 18a,b thus represents a segment of the vessel tree of the patient 2 through which the contrast agent 14 flows at the point in time of the acquisition, thus a momentary exposure.

The contrast exposures 18a,b are merged in an adder 20 into an accumulated contrast image 22, also called a maximum opacification image. All blood vessels 16a-c through which contrast agent 14 flowed in the course of the production of the contrast exposures are then visible in the accumulated contrast image 22.

Moreover, each of the contrast exposures 18a,b passes through a subtractor 24 in which the mask image 10 is subtracted from the respective contrast exposure 18a,b. In the case of the contrast exposure 18a, a vessel image 26a thus results which shows only the contrasted blood vessel 16a. The head 8 and the shoulder region 12 of the patient are identical in both in the mask image 10 and the contrast exposure 18a and are removed by the subtractor 24 from the corresponding result x-ray image, thus the vessel images 26a,b.

The preparations for a vascular surgery procedure on the patient are made with the presence of the mask image 10 and the accumulated vessel image 30 as well as the accumulated contrast image 22.

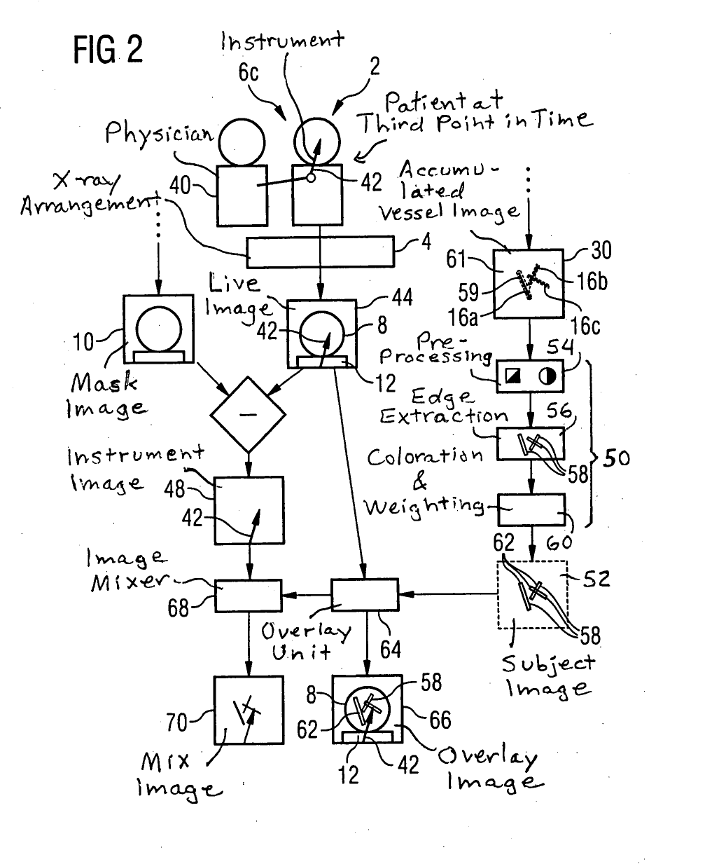

FIG. 2 shows the patient at a later point in time 6c, for example a few minutes after the point in time 6b. A physician 40 implements a vascular surgery measure on the patient 2 at the point in time 6c and for this has inserted an instrument 42 (for example a catheter) into the head 8 of the patient 2 or the vessel tree thereof with the blood vessels 16a-c.

In order to recognize at which point the instrument 42 is directly located in the patient 2, a further x-ray image (namely a live image 44 of the patient 2) is acquired at the point in time 6c with the aid of the x-ray arrangement 4. The live image 44 is also again a native image, meaning that the head 8 and the shoulder region 12 of the patient 2 are recognizable together with the instrument 42. The live image 44 is, for example, a moving duration x-ray image or stands representatively for a series of individual x-ray images acquired at short time intervals.

The contrast agent 14 in the meantime has been completely absorbed by the patient 2. The blood vessels 16a-c are therefore not or only insufficiently recognizable on the live image 44 and on the mask image 10.

Depending on the personal preference of the physician 40, he or she operates, for example, with the live image 44 in the form of the native image or also with a subtraction image. The live image 44 is therefore directed to a further subtractor 46 together with the mask image 10 or a mask image from FIG. 1 (not shown) newly generated before the insertion of the catheter. This thereupon supplies an instrument image 48 in which the image contents of the head 8 and the shoulder region 12 are removed again via the subtraction. Only the instrument 42 is therefore visible on the instrument image 48, comparable to the vessels 16a-c in the vessel images 26a,b.

All x-ray images are displayed to the physician 40 on a first screen (not shown). According to the prior art, a vascular surgery was previously monitored by the physician 40 in that he monitored the live image 44 or instrument image 48 on the first screen and thereby additionally observed the accumulated vessel image 30 or the accumulated contrast image 22. This ensued, for example, on a second separate screen (not shown) or on the same first screen in temporal alternation or via simple unprepared superimposition.

According to the invention the accumulated vessel image 30 is now processed in various image processing steps 50 into a subject image 52. A pre-processing step 54 hereby ensues in the example in FIG. 2. For example, the accumulated vessel image is extracted there into a blank image in step 54. A brightness or contrast normalization of the vessel image 30 or a corresponding other image preparation can additionally ensue in step 54, for example.

An edge extraction 56 in which the contour lines 58 of the blood vessels 16a-c and therewith the imaging region 59 of the subject of interest are determined ensues subsequently. The image region 61 surrounding the imaging region 59 is deleted. All following image operations are conducted only in the imaging region 59.

A coloration and weighting 60 of the pre-processed, accumulated vessel image 30 subsequently ensues in which the blood vessels 16a-c are shown with the same brightness and/or the lumen 62 of the blood vessels 16a-c are subsequently colored in, for example, green and the contour lines are colored in, for example, red.

In a first alterative, in an overlay unit 64 the subject image 52 is now superimposed on the live image 44 as a semi-transparent layer. An overlay image 66 is thus created as a sum image in which, in addition to the anatomy of the patient (namely his head 8 and shoulder region 12), the instrument 42 and the blood vessels 16a-c adapted in terms of contrast and brightness and emphasized with contour lines 58 and lumen 62 are blended together with spatial accuracy. Such an overlay image 66 serves for the orientation of the physician 40 during the vascular surgery procedure.

In order to provide the physician 40 with an alternative for the representation of the sum image, the subject image 52 is moreover mixed with the instrument image 48 in an image mixer 68. Alternatively a mix image 70 is created as a sum image that differs from the overlay image 66 in that the anatomy of the patient (namely his head 8 and shoulder region 12) is not shown. Moreover, due to the image mixing the graphical representation of instrument 42 and blood vessels 16a-c is altered in comparison to the overlay technique.

The entirety of the image processing steps in FIGS. 1 and 2 as well as a possible storage (not shown) of x-ray images for image processing as well as image overlay or image mixing are handled by a medical image processing system (not shown). This can be, for example, a computer workstation connected to the x-ray apparatus 4.

According to the invention, an overlay image 66 or mix image 70 is thus available to the physician in which, in contrast to the prior art, both the instrument 42 and the blood vessels 16a-c are, for example, simultaneously superimposed in a symbolic representation via counter lines 58 or also in an improved but more realistic representation of the lumen 62.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for generating an x-ray image of a subject in a patient, comprising the steps of:
generating a first x-ray image showing the subject in the patient;
generating a subject image from said first x-ray image comprising only image information in the imaging region, containing said subject in said first x-ray image, by removing image regions of said first x-ray image other than said imaging region containing said subject;
generating a second x-ray image of an anatomical region of the patient containing the subject; and
positionally accurately associating said subject image with said second x-ray image and combining said subject image with said second x-ray image to form a sum image.

2. A method as claimed in claim 1 comprising generating said subject image by edge extraction of said first x-ray image.

3. A method as claimed in claim 1 comprising coloring at least one of said first x-ray image and said subject image.

4. A method as claimed in claim 1 comprising generating said subject image with normalization of at least one characteristic, selected from the group consisting of brightness and contrast, of at least one of said first x-ray image and said subject image.

5. A method as claimed in claim 4 comprising non-linearly preparing said characteristic of said at least of said first x-ray image and said subject image.

6. A method as claimed in claim 1 comprising weighting at least one of said subject image and said second x-ray image when combining said subject image and said second x-ray image for form said sum image.

7. A method as claimed in claim 1 comprising combining said subject image with said second x-ray image to form said sum image by image overlay.

8. A method as claimed in claim 1 comprising graphically emphasizing said subject in said first x-ray image by administering a contrast agent to the patient while acquiring said first x-ray image.

9. A method as claimed in claim 1 comprising acquiring said first x-ray image as an image selected from the group consisting of a native image and a subtraction image.

10. A method as claimed in claim 1 comprising acquiring said second x-ray image as an image selected from the group consisting of a native image and a subtraction image.

11. A method as claimed in claim 1 comprising generating said first x-ray image as an image wherein said subject is a vessel structure of the patient.

12. A method as claimed in claim 1 comprising generating said second x-ray image and said sum image in a vascular surgery procedure.

13. A method as claimed in claim 1 comprising generating said sum image as a roadmap image allowing a visual orientation of the subject.
